(19) United States
(12) Patent Application Publication
(10) Pub. No.: US 2014/0342256 A1
(43) Pub. Date: Nov. 20, 2014

(54) PROCESS FOR PRODUCING AN ADJUSTABLE GAS COMPOSITION FOR FUEL CELL APPLICATION

(71) Applicant: TOPSØE FUEL CELL A/S, Kgs. Lyngby (DK)

(72) Inventors: Hassan Modarresi, Lyngby (DK); Pedro Nehter, Charlottenlund (DK)

(73) Assignee: Topsøe Fuel Cell A/S, Kgs. Lyngby (DK)

(21) Appl. No.: 14/365,249

(22) PCT Filed: Nov. 21, 2012
(86) PCT No.: PCT/EP2012/073162

§ 371 Date: Jun. 13, 2014

(30) Foreign Application Priority Data
Dec. 15, 2011 (DK) PA 2011 00970

(51) Int. Cl. H01M 8/06

(52) U.S. Cl. CPC H01M 8/0618; H01M 2008/1293
USPC 429/425

(57) ABSTRACT

A method for producing an adjustable gas composition to be used as an anode gas for a fuel cell, such as a solid oxide fuel cell (SOFC), is performed in a system comprising (a) a fuel processing unit (1), wherein a hydrocarbon fuel raw material is converted to reformate gas, a combustion unit (2), wherein the reformate gas from the fuel processing unit (a) is partially or completely burned with an oxygen gas source, and (c) a post-processing unit (3), wherein the equilibrium composition of the reformate gas is catalytically changed by varying the temperature of the catalytic bed in the unit or by partially combusting the feed gas to the post-processing unit in the preceding combustion unit (2).

The present invention relates to a method for producing an adjustable gas composition to be used as an anode gas for fuel cell, such as solid oxide fuel cell, application. The invention further relates to a system for carrying out the method by converting a fossil fuel to an adjustable gas composition.

More specifically, the invention relates to a method in which a hydrocarbon fuel raw material is first converted to syngas in a fuel processing unit, whereupon the syngas is either completely or partially combusted and then subjected to a post-processing treatment. This treatment changes the equilibrium composition of the syngas catalytically by varying the temperature of the catalytic bed, which is done by removing (or adding) heat from (or to) the post-processing unit prior to feeding the resulting syngas to a solid oxide fuel cell (SOFC) anode.

This method, which is a novel combination of known processes, is not described or suggested in the prior art. According to US 2008/0141590 A1, a catalytic reformer assembly is used to generate reformate from hydrocarbon fuels for fuelling an energy producing source such as an SOFC assembly, in which case a tail gas (syngas) is emitted from the anodes, said syngas containing a significant amount of residual hydrogen and carbon monoxide. A portion of the anode syngas is recycled to a fuel vaporizer, such that the fuel dispersed in the vaporizer is fully vaporized and heated prior to being combined with air for exothermic reforming.

Another fuel processing method for a solid oxide fuel cell system is described in US 2010/0104897 A1. Said method can completely remove a hydrocarbon remaining in a reformed gas, thereby preventing deteriorated fuel cell performance. The method comprises (a) obtaining a hydrogen-rich reformed gas using a desulfurizer and a primary reformer that reforms the hydrocarbon-based fuel to generate the hydrogen-rich reformed gas, and (b) selectively decomposing a C₂-C₅ hydrocarbon contained in the desulfurized reformed gas and converting it into hydrogen and methane by using a post-reformer.

In EP 0 673 074 B1 a fuel cell arrangement is described, said fuel cell arrangement comprising a pre-reformer, which is supplied with anode off-gas containing hydrogen and steam from the fuel cells, and which is fed with a hydrocarbon fuel. The pre-reformer comprises a catalyst suitable for low temperature steam reforming of the hydrocarbon fuel and a catalyst for partial oxidation reforming of the hydrocarbon fuel. The pre-reformer also comprises a catalyst suitable for hydrodesulphurization of the hydrocarbon fuel.

SOFC anodes containing nickel are highly active towards the electrochemical oxidation of hydrogen and at the same time very prone to carbon formation from higher hydrocarbons. Fuels containing higher hydrocarbons are converted to a mixture of hydrogen, water, carbon monoxide, carbon dioxide and methane prior to entering the SOFC stack in order to avoid carbon formation on the anode. The most established processes for this conversion are steam reforming (SR), partial oxidation (CPO/PDX) and auto-thermal reforming (ATR).

Steam reforming is a principle technology to generate hydrogen from natural gas, e.g. with the aid of a nickel catalyst, where a hydrocarbon reacts with steam to form carbon monoxide and hydrogen. At ambient pressures, methane is almost completely converted at temperatures above 850° C. On the other hand, the equilibrium constant of the shift reaction (a reaction where carbon monoxide reacts with water to form carbon dioxide and hydrogen) decreases at higher temperatures, where lower fractions of hydrogen and carbon dioxide are expected.

The reforming and the shift reaction occur simultaneously, resulting in a maximum CO₂ content at 600° C. under conditions of ambient pressure. Simulated equilibrium compositions for the steam reforming and partial oxidation of methane are given in the table below. The reformate gas may contain methane in amounts ranging from a few ppm up to about 18% at reforming temperatures of between 750° C. and 550° C., a typical operating temperature range for heated and adiabatic steam reformers.

Equilibrium composition of natural gas (100% CH₄) reformate
at O/C = 2 and 1 bar absolute pressure

| Reformate | | | | |
|---|---|---|---|---|
| composition | SR 500° C. | SR 750° C. | CPO 500° C. | CPO 750° C. |
| m.f. CH₄ | 0.178 | 0.004 | 0.092 | 0.001 |
| m.f. H₂O | 0.371 | 0.159 | 0.203 | 0.122 |
| m.f. CO₂ | 0.077 | 0.047 | 0.090 | 0.048 |
| m.f. CO | 0.014 | 0.149 | 0.019 | 0.120 |
| m.f. H₂ | 0.356 | 0.638 | 0.215 | 0.386 |
| m.f. N₂ | 0 | 0 | 0.378 | 0.320 |

m.f. = mole fraction

A flexible anode gas composition would be very favourable in order to adjust the methane and carbon monoxide content to the begin-of-life (BOL) and the end-of-life (EOL) requirements of the fuel cell stack. Under BOL conditions, less methane is tolerated because of the fast kinetics and strong cooling effect of the internal reforming. Thus, a high post-processor temperature would be desirable to reduce the amount of methane (cf. the above table, SR 750° C., SR 750° C.). After the first sulphur layer has been established on the anode or any other mechanism, which would lower the anode activity for methane reforming, has taken place, the tendency towards carbon formation is lower, whereas the internal reforming is much slower and the shift reaction is partly inhibited. A higher methane flow can thus be handled with decent temperature gradients at the entry of the anode. Consequently, a lower post processor temperature would be desirable (SR 500° C., SR 500° C. in the above table). Under EOL conditions a high internal cooling effect is even more desirable because of the increasing heat production in the fuel cell stack.

The endothermic nature of the steam reforming makes methane in the anode gas an effective cooling agent which reduces the parasitic losses of the air blower and increases the electrical efficiency of the system. The internal reforming of methane has its limits in the temperature gradients taking place at the entry of the anode. The faster the reforming reaction, the higher the temperature gradient will be. The reforming kinetics on Ni-anodes is strongly related to the presence of sulphur. There is general consensus in literature that sulphur has an immediate impact on the electrochemical performance of Ni anodes as well as on the reforming, shift reaction and carbon formation.

In an SOFC stack, the risk of carbon formation downstream of the fuel processing unit is a challenging issue during start up and shut down of the system. This is mainly due to a Boudouard reaction triggered by the low temperature of the SOFC stack. Since the Boudouard reaction is an equilibrium reaction expressed by the equation 2CO←→CO₂+C, a reduction of the carbon monoxide partial pressure will lower the risk of carbon formation, particularly on the anode surface. Moreover, unsaturated hydrocarbons higher than methane, mainly olefins, may be produced along with the syngas in the fuel processing unit. These species are suspected to form gum deposits on the anode and other surfaces at lower temperatures. To avoid carbon depositions during start up and shut down of the system, the fuel cell stack should be heated up to above a certain safe temperature in such a way that carbon monoxide and higher hydrocarbons from the reformate gas are converted to non-carbon forming compounds. This can be done with a fuel processing unit generating syngas whose composition can be varied.

Therefore, the present invention relates to a method for producing an adjustable gas composition to be used as an anode gas for fuel cell application, such as SOFC application. The method of the invention comprises the following steps:

(a) treating the hydrocarbon fuel raw material in a fuel processing unit,

(b) optionally processing the product gas from step (a) by partial or complete combustion with an oxygen gas source in a combustion unit and

(c) changing the composition of the product gas obtained from step (b) in a post-processing unit by varying the temperature.

The invention also relates to a system for converting a fossil fuel to an adjustable gas composition by the above process. The system according to the invention is shown on the accompanying drawings, where:

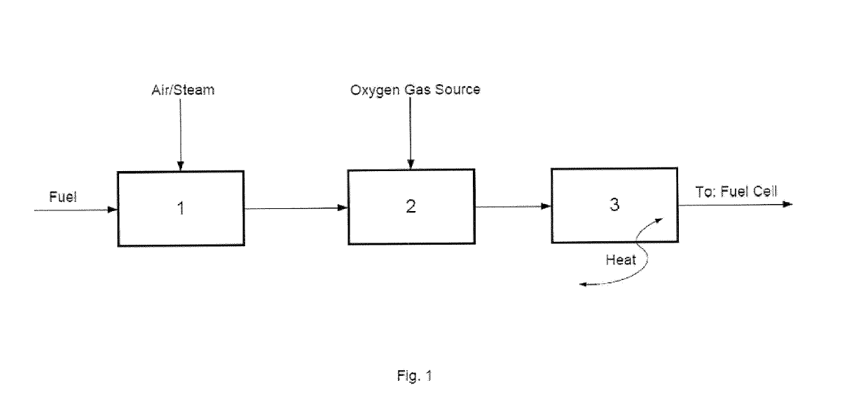

FIG. 1 is a general outline of the system according to the invention,

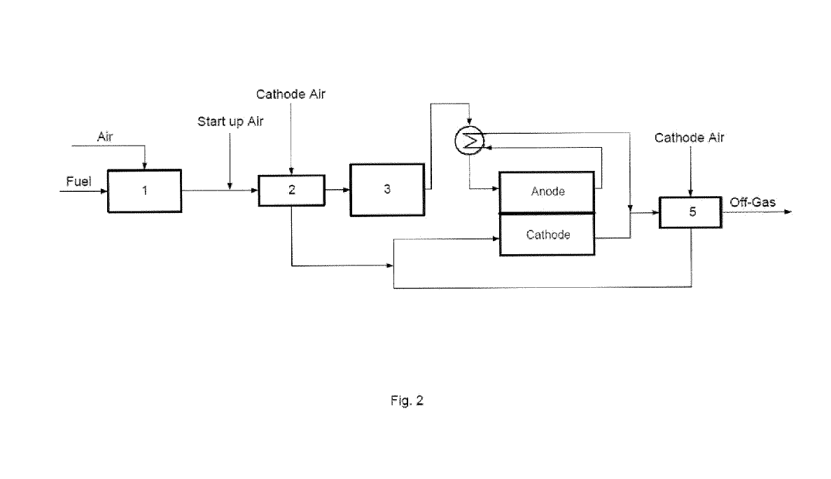

FIG. 2 is an illustration of the system used in connection with a specific embodiment of the method of the invention as described in Example 1 below, and

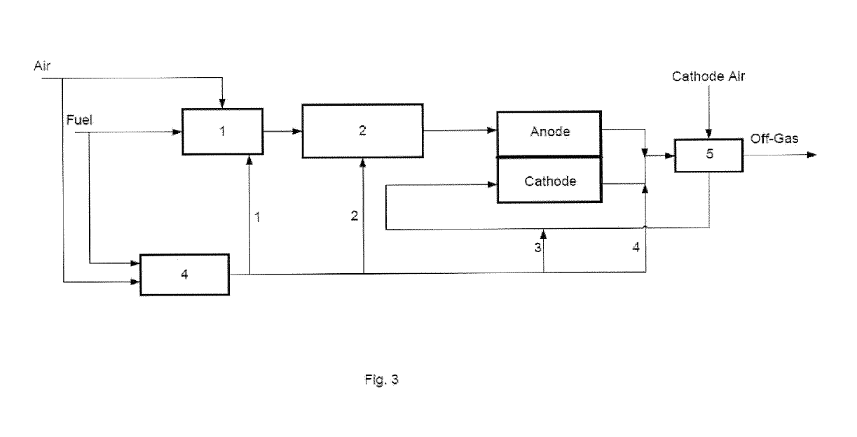

FIG. 3 is an illustration of the system used in connection with another specific embodiment of the method of the invention as described in Example 2 below.

In general, the system according to the invention comprises:

(a) a fuel processing unit 1, wherein a hydrocarbon fuel raw material is converted to reformate gas,

(b) an optional combustion unit 2, wherein the reformate gas from the fuel processing unit (a) is partially or completely burned with an oxygen gas source, and

(c) a post-processing unit 3, wherein the equilibrium composition of the reformate gas is catalytically changed by varying the temperature of the catalytic bed in the unit or by partially combusting the feed gas to the post-processing unit in the preceding combustion unit 2.

According to the above general process embodiment, reformate gas from the fuel processing unit 1, produced by reacting a fuel with air or steam or a combination thereof, is processed in two subsequent steps, more specifically a combustion step in the combustion unit 2 to combust the reformate gas, either completely or partially, and a post-processing step in the post-processing unit 3 to change the equilibrium composition of the reformate gas catalytically, either by variation of the catalytic bed temperature by removing (or adding) heat from (or to) the post-processing unit or by partially combusting the feed gas to the post-processing unit 3 in the combustion unit 2.

The present invention utilises hydrocarbon fuels, which contain both H and C in various ratios. Examples of hydrocarbon fuels include saturated hydrocarbons (e.g. methane, ethane, propane and butane), natural gas, biogas, gasoline, gasified coal or biomass, diesel, synthetic fuels, marine fuel and jet fuels. The term “hydrocarbon fuels” also includes alcohols commonly used as fuels, e.g. methanol, ethanol and butanol.

The fuel raw material is preferably a fossil fuel and/or a synthetic fuel, and the reformate gas from step (a) is preferably syngas.

In a preferred embodiment of the method, carbon monoxide is converted to hydrogen and carbon dioxide through a shift reaction in step (c). In another preferred embodiment of the method, carbon monoxide is converted to methane through a methanation reaction in step (c).

Preferably the temperature in step (c) is varied by using either an internal or an external heat source/sink or both an internal and an external heat source/sink or by partially combusting the feed gas to the post-processing unit in the preceding combustion unit.

The system as described above preferably also comprises an auxiliary burner 4, which produces a hot flue gas to be used for optionally heating of the fuel processing unit, for partially combusting of hydrogen or carbon monoxide generated in the fuel processing unit or for heating of the fuel cell via the cathode channel. The system may comprise a further burner 5 to heat up the cathode air.

The invention is illustrated further by the following examples.

### EXAMPLE 1

This example illustrates a process where the fuel processing starts up and produces reformate gas in the fuel processing unit 1. In the following step, the reformate gas from the unit 1 is burnt with start-up air in the burner 2, where the generated heat is recovered by cathode air. The flue gas from the burner 2, which is without hydrogen and carbon monoxide, is used to heat up the downstream components to a temperature below a certain safe temperature at which there is no significant risk regarding oxidation of the catalysts.

In the next step, the post-processing unit 3, which comprises either a desulphurization and shift/methanation catalyst or a sulphur resistant shift/methanation catalyst, converts carbon monoxide to hydrogen and carbon dioxide (shift reaction) or methane (methanation). The processed gas leaving the post-processing unit is fairly free from carbon monoxide and rich in hydrogen and methane.

### EXAMPLE 2

In this example an auxiliary burner 4 operates with excess air and produces flue gas with a small amount, typically a few %, of oxygen. The hot flue gas is used to optionally heat the fuel processing unit (stream 1), partially combust hydrogen and carbon monoxide generated in the fuel processing unit by the flue gas oxygen in the catalytic syngas burner (stream 1 or 2 or both), heat up the fuel cell stack via the cathode channel (stream 3) or heat up the cathode air via the burner 5 (stream 4).

1. A method for producing an adjustable gas composition to be used as an anode gas for a fuel cell, such as a solid oxide fuel cell (SOFC), comprising the following steps:
(a) treating the hydrocarbon fuel raw material in a fuel processing unit,
(b) processing the product gas from step (a) in a combustion unit by partial or complete combustion with an oxygen gas source and
(c) changing the composition of the product gas obtained from step (b) by varying the temperature in a post-processing unit,
wherein reformate gas is burned with air, and wherein the flue gas from the burning, which is devoid of hydrogen and carbon monoxide, is used to heat up the downstream components to below a safe temperature at which there is no risk regarding oxidation of the catalysts.

2. Method according to claim 1, wherein the post-processing unit, which comprises either a desulphurization and shift/methanation catalyst or a sulphur resistant shift/methanation catalyst, converts carbon monoxide to hydrogen and carbon dioxide (shift reaction) or to methane (methanation).

3. Method according to claim 1, wherein the hydrocarbon fuel raw material is a fossil fuel and/or a synthetic fuel.

4. Method according to claim 1, wherein the product gas from step (b) is syngas.

5. Method according to claim 1, wherein the fuel in step (a) is reacted with air, steam, anode recycle or any recycle from within steps (a) to (c) or combinations thereof.

6. Method according to claim 1, wherein anode recycle is added anywhere downstream step (a) in one or more positions.

7. Method according to claim 1, wherein the temperature in step (c) is varied by using either an internal or an external heat source/sink or both an internal and an external heat source/sink or by partially combusting the feed gas to the post-processing unit in the preceding combustion unit.

8. Method according to claim 1, wherein the composition change in step (c) is carried out by an equilibrium or non-equilibrium type reaction over a catalyst.

9. Method according to claim 1, wherein the combustion unit in step (b) is a catalytic combustion unit.

10. Method according to claim 1, wherein carbon monoxide is converted to hydrogen and carbon dioxide through a shift reaction in step (c).

11. Method according to claim 1, wherein carbon monoxide is converted to methane through a methanation reaction in step (c).

12. Method according to claim 1, wherein a hot flue gas containing a small amount of oxygen, produced in an auxiliary burner, is used to heat the fuel processing unit, to partially combust hydrogen and carbon monoxide generated in the fuel processing unit by the flue gas oxygen in the catalytic syngas burner, to heat up the fuel cell stack via the cathode channel or to heat up the cathode air via a further burner.

13. A system for converting a fossil fuel to an adjustable gas composition by the process according to any of the preceding claims, said system comprising:
(a) a fuel processing unit, wherein a hydrocarbon fuel raw material is converted to reformate gas,
(b) a combustion unit, wherein the reformate gas from the fuel processing unit (a) is partially or completely burned with an oxygen gas source, and
(c) a post-processing unit, wherein the equilibrium composition of the reformate gas is catalytically changed by varying the temperature of the catalytic bed in the post-processing unit or by partially combusting the feed gas to the post-processing unit in the preceding combustion unit.

14. System according to claim 13, further comprising an auxiliary burner, which produces a hot flue gas to be used for optionally heating of the fuel processing unit, for partially combusting of hydrogen or carbon monoxide generated in the fuel processing unit or for heating of the fuel cell via the cathode channel.

15. System according to claim 13, comprising a further burner, which is used for heating up the cathode air.

16. (canceled)
